(19) United States
(12) Patent Application Publication
(10) Pub. No.: US 2011/0036210 A1
(43) Pub. Date: Feb. 17, 2011

(54) WRENCH TOOL

(76) Inventor: Young-Doo Kwon, Daegu (KR)

Correspondence Address: CHRISTIE, PARKER & HALE, LLP, PO BOX 7068, PASADENA, CA, 91109-7068, US

(21) Appl. No.: 12/854,802

(22) Filed: Aug. 11, 2010

(30) Foreign Application Priority Data
Aug. 12, 2009 (KR) 20-2009-0010508

(51) Int. Cl. B25B 13/06; B25B 23/16

(52) U.S. Cl. 81/124.7; 81/177.2

(57) ABSTRACT

A wrench tool used in fastening or unfastening a bolt or nut. The wrench tool includes a head having a socket formed in an axial direction thereof such that an outer circumference of the bolt or the nut can be inserted into the socket and a rod connected to one end of the head. The rod includes a bent section extending from the one end of the head in the axial direction of the head and a connector rod connected to one end of the bent section and extending a predetermined length. The bent section is curved to define an opening in one side thereof. The wrench tool is extensible in length, and the moment generated by a force applied by a user to be consistent with the rotational direction of the bolt or nut so that the bolt or the nut can be fastened or unfastened using less force.

### CROSS REFERENCE TO RELATED APPLICATION

The present application claims priority from Korean Patent Application Number 20-2009-0010508 filed on Aug. 12, 2009, the entire contents of which application is incorporated herein for all purposes by this reference.

### BACKGROUND OF THE INVENTION

1. Field of the Invention

The present invention relates to a wrench tool used in fastening or unfastening a bolt or a nut, and more particularly, to a wrench tool, which is one-way extensible in length, and in which the moment generated by a force applied by a user when fastening or unfastening a bolt or a nut is set to be consistent with the rotational direction of the nut or the like so that the bolt or the nut can be fastened not exceeding design force to prevent bolt failure, and unfastened using less force for weak men

2. Description of Related Art

A wheel nut wrench is one of the tools included with On-Vehicle Materials (OVM), which are provided in the delivery of a vehicle, so that a driver can replace a flat tire by himself/herself.

A wheel nut wrench 1 of the related art has a head 10, which is intended to be coupled with a wheel nut, and a handle 30 having a predetermined length, the handle 30 connected to the head 10 via a bent section 20. The bent section 20 is bent almost perpendicularly with respect to the length of the wheel nut 1.

In the wheel nut wrench 1 of the related art, the head 10 is connected with the handle 30 via the bent section 20, which is almost perpendicularly bent as shown in FIG. 1. When a user applies force in order to unfasten a wheel nut, a force f, which is intended to be transmitted to the head 10, is transmitted to the head 10 in a direction that is inclined at a predetermined angle relative to the bent section 20. Accordingly, there is a problem in that the force is not properly transmitted.

In addition, there is another problem in that the outer circumference of a bolt or a nut is broken or damaged, since not exactly aligned force is applied to the bolt or the nut when the bolt and the nut are fastened together.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a wrench tool that has a bent section extending a predetermined length from a head in the axial direction, which is intended to be coupled with a bolt or a nut, such that a force applied by a user can be properly transmitted.

Also provided is a wrench tool that has a foldable extension configured to increase the length of a connector rod, which the user grasps, in order to increase the length of a moment arm when unfastening a bolt or a nut, so that the bolt or the nut can be easily unfastened using less force.

In an aspect of the present invention, the wrench tool used in fastening or unfastening a bolt or nut includes a head having a socket formed in the axial direction thereof such that the outer circumference of the bolt or the nut can be inserted into the socket; and a connector rod connected to one end of the head. The rod includes a bent section extending from the one end of the head in the axial direction of the head and a connector rod connected to one end of the bent section and extending a predetermined length. The bent section is curved to define an opening in one side thereof.

In an exemplary embodiment of the invention, the opening may be formed in the one side of the bent section where the connector rod is connected to the bent section.

In an exemplary embodiment of the invention, the opening may be formed to be symmetrical in the axial direction of the head, with the central point of the opening being on the axial line of the head.

In an exemplary embodiment of the invention, the rod may further include an extension provided on one end of the connector rod, the extension being foldable relative to the bent section.

In an exemplary embodiment of the invention, the wrench tool may further include a fixing member provided between the connector rod and the extension. The connector and the extension can be fixedly fitted into the fixing member.

As set forth above, since the bent section extends a predetermined length from the head, which is intended to be coupled with the bolt or the nut, in the axial direction, the moment generated by the force applied by the user is transmitted to be consistent with the direction in which the nut or the like is rotated. Thereby, there is an effect in that the bolt or the nut is prevented from being broken.

In addition, since the extension is configured to be foldable in order to increase the length of the connector rod, which the user grasps, the user can easily unfasten the bolt or the nut using less force by increasing the length of a moment arm when unfastening a bolt or a nut.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic view showing a wrench tool of the related art;

FIG. 2 is a perspective view showing a wrench tool according to an exemplary embodiment of the invention;

FIG. 3 is an exploded perspective view showing the wrench tool shown in FIG. 2;

FIGS. 4A and 4B are explanatory views showing a structural analysis of the wrench tool shown in FIG. 2;

FIGS. 5A and 5B are perspective views showing applications of the wrench tool shown in FIG. 2; and

FIGS. 6A and 6B are cross-sectional views showing coupling states between a connector rod and an extension of a wrench tool according another exemplary embodiment of the invention.

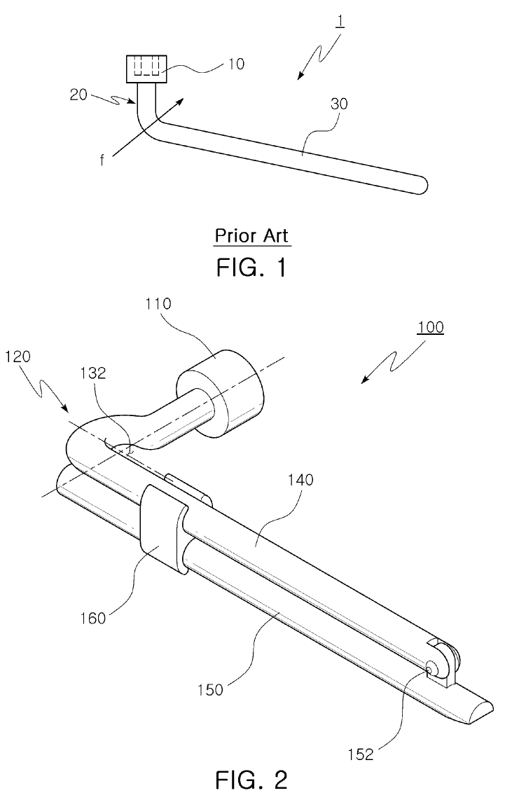

### DETAILED DESCRIPTION OF THE INVENTION

Reference will now be made in detail to various embodiments of the present invention(s), examples of which are illustrated in the accompanying drawings and described below. Throughout this document, reference should be made to the drawings, in which the same reference numerals and signs are used throughout the different drawings to designate the same or similar components.

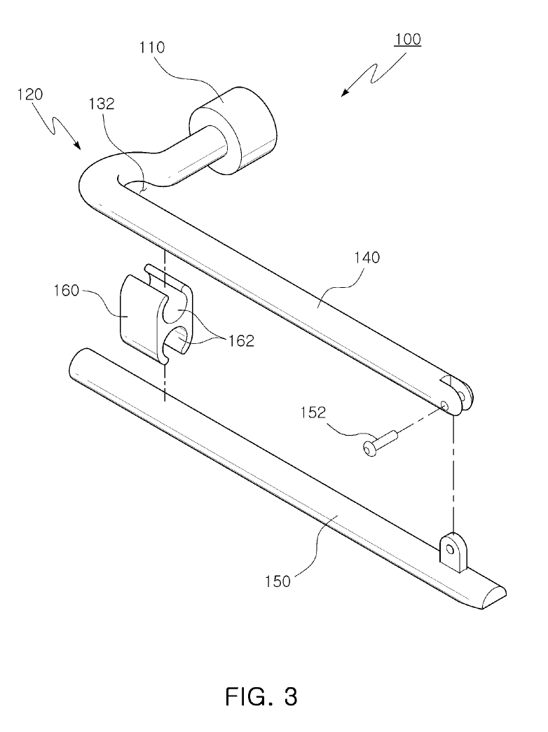

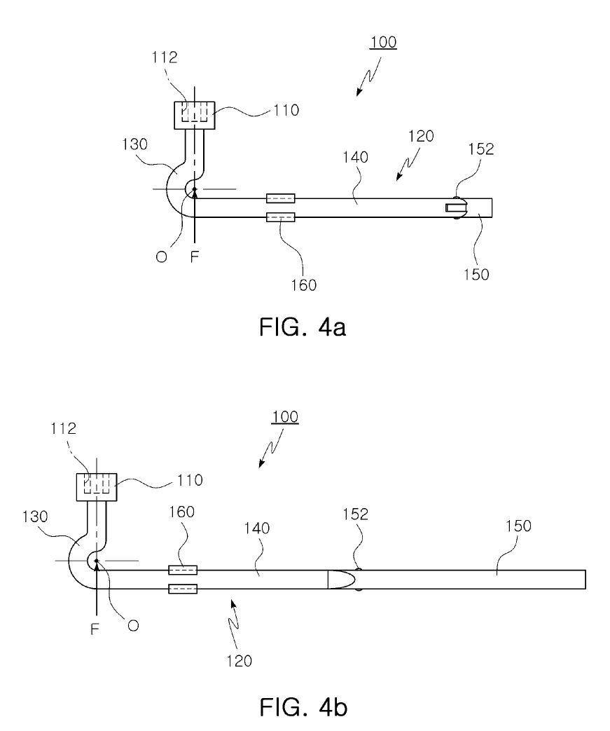

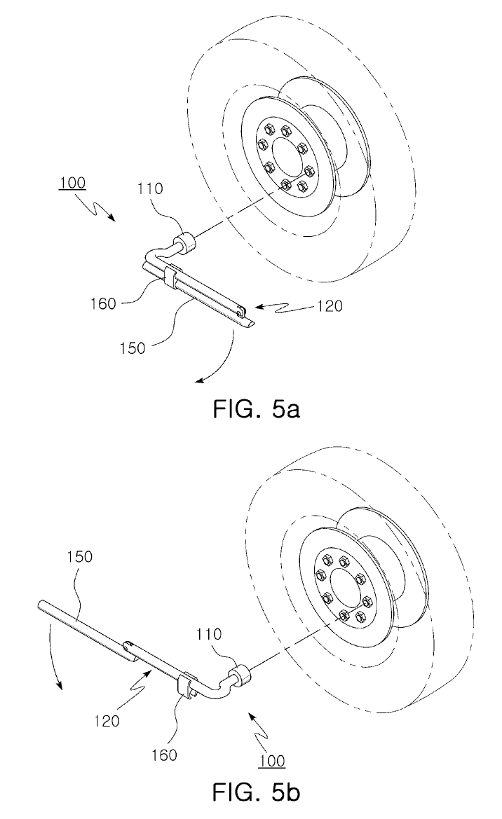

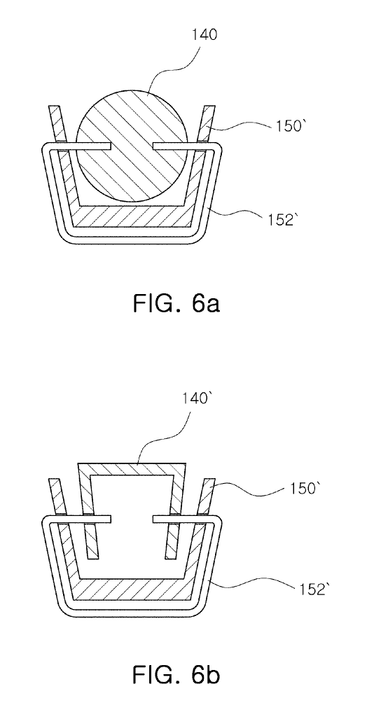

FIG. 2 is a perspective view showing a wrench tool according to an exemplary embodiment of the invention, FIG. 3 is an exploded perspective view showing the wrench tool shown in FIG. 2, FIGS. 4A and 4B are explanatory views showing a structural analysis of the wrench tool shown in FIG. 2, FIGS. 5A and 5B are perspective views showing applications of the wrench tool shown in FIG. 2, and FIGS. 6A and 6B are cross-sectional views showing coupling states between a connector rod and an extension of a wrench tool according another exemplary embodiment of the invention.

The wrench tool 100 according to an exemplary embodiment of the invention is a tool that is used to fasten or unfasten a nut or the like by applying a force from one end thereof, which is coupled with the outer circumference of a bolt or nut (hereinafter, referred to as a “nut or the like”). The wrench tool 100 of this embodiment includes a head 110 and a rod 120.

The head 110 has a socket 112, which is recessed a predetermined depth in the axial direction, as in a typical wrench tool, so that the outer circumference of the nut or the like can be inserted. The socket 112 has a polygonal cross section, preferably a hexagonal or rectangular cross section. The size of the socket 112 is similar to that of a typical nut or the like.

The rod 120 is connected to the rear end of the head 110, and serves to transmit a force, which is applied to one end thereof from a user, to the head 110. The rod 120 includes a bent section 130 and a connector rod 140.

The bent section 130 is connected to the rear end of the head 110 and extends a predetermined length in the longitudinal direction of the head 110. The bent section 130 is curved such that an opening 132 is defined in one side thereof.

Here, it is preferred that the opening 132 be formed in the side of the bent section 130 where the connector rod 140 is connected, such that the direction of the force transmitted through the connector rod 140 is parallel with the axial direction of the head 110.

In addition, it is preferred that the opening 132 have a semicircular shape or a semi-oval shape, which is symmetrical in the vertical direction (in FIG. 4), i.e., the axial direction of the head 110. The central point O of the semicircular or semi-oval opening 132 is positioned to be collinear with the axial line A of the head 110.

Since the bent section 130 connected to the head 110 is curved as above, the following technical feature is realized: When the user applies a force to one end of the connector rod 140 in order to fasten or unfasten the nut or the like, a force F can be generated in the same direction as the axial direction of the head 110 due to the bent section 130 as shown in FIG. 4.

Since the force F is transmitted in the same direction as the axial direction of the head 110 via the bent section in response to the force applied by the user, it generates a moment that is transmitted in the same direction as the rotational direction of the nut or the like, thereby preventing the nut or the like from being broken. In addition, this requires less force than the wrench tool of the related art, and thus the nut or the like can be easily fastened and unfastened.

The connector rod 140 extends a predetermined length such that the user can grasp it to apply force when fastening or unfastening the nut or the like. The connector rod 140 is a member that is connected to one end of the socket 132 and extends perpendicular to the axial direction of the head 110.

The connector rod 140 extends a length that is similar to that of a wrench tool of the related art. It is preferred that the connector rod 140 extend a length such that excessive moment is not applied to the nut or the like when the nut or the like is fastened.

Here, an extension 150 having a predetermined length can be foldably provided on one end (particularly, one end opposite the bent section 130) of the connector rod 140. As shown in FIGS. 2 to 4, the extension 150 is coupled to one end of the connector rod 140 via a coupling 152 such as a hinge.

With the extension 150 foldably coupled with the connector rod 140, the user can increase the length of a moment arm by stretching the extension 150 so that the length of the rod 120 can be increased when the nut or the like is unfastened.

As a result, the user can easily unfasten the nut or the like using less force.

In addition, since the extension 150 is foldably provided on the connector rod 140, it is possible to fold the extension 150 when storing the wrench tool. Therefore, user convenience is improved since the user can store and carry the wrench tool in a more compact format.

Here, the extension 150 provided on one end of the connector rod 140 is configured such that it is arranged to face the surface of the paper in FIG. 4 when it is folded. Thus, as shown in FIG. 5, the wrench tool is used with the extension 150 folded to the connector rod 140 when the nut or the like is fastened. When unfastening the nut or the like, the extension 150 is stretched from one end of the connector rod 140, so that the user can apply a greater force to the head with less force.

As shown in FIG. 6, one of the connector rod and the extension can be formed as a “C” shaped beam, which is open in one side thereof and has a hollow inner space. This configuration can reduce the weight of the wrench tool. It is preferred that an extension 150′ coupled to one end of the connector rod 140 is formed as a “C” shaped beam, which is foldable via a coupling 152′ (see FIG. 6A).

In addition, both a connector rod 140′ and the extension 150′ can be formed as a “C” shaped beam, which is open in one side thereof and has a hollow inner space, so that the open side of the connector rod 140′ or the extension 150′ can be inserted into the open side of the counterpart and folded via a hinge 152′. This configuration can reduce the weight of the wrench tool (see FIG. 6B).

The wrench tool 100 according to an exemplary embodiment of the invention may also have a fixing member 160, which is provided to hold both the extension 150 and the connector rod 140. Specifically, the fixing member 160 can fix the extension 150 and the connector rod 140 when they are inserted into the fixing member 160. The fixing member 160 is made of an elastic rubber material, and has fitting grooves 162 in the upper and lower sides thereof.

That is, when the extension 150 is folded toward the connector rod 140, the extension 150 and the connector rod 140 are interference-fitted into the fitting grooves 162, respectively, so that the extension 150 and the connector rod 140 are fixed in the folded state without coming into contact with each other.

Since the fixing member 160 is provided between the extension 150 and the connector rod 140 so that the extension 150 and the connector rod 140 are folded relative to each other with an interval, it is possible to prevent fingers from being caught between the extension 150 and the connector rod 140 while the user is grasping the extension 150. In the case of stretching the extension 150 in order to generate large force to unscrew the nut or the like, it is possible to easily stretch the extension 150 using the interval.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wrench tool used in fastening or unfastening a bolt or nut, comprising:
a head having a socket formed in an axial direction thereof such that an outer circumference of the bolt or the nut can be inserted into the socket; and
a rod connected to one end of the head, wherein the rod includes a bent section extending from the one end of the head in the axial direction of the head and a connector rod connected to one end of the bent section and extending a predetermined length,
wherein the bent section is curved to define an opening in one side thereof.

2. The wrench tool according to claim 1, wherein the opening is formed in the one side of the bent section where the connector rod is connected to the bent section.

3. The wrench tool according to claim 1, wherein the opening is formed to be symmetrical in the axial direction of the head, with a central point of the opening being on an axial line of the head.

4. The wrench tool according to claim 1, wherein the rod further includes an one-way extension provided on one end of the connector rod, the extension being foldable relative to the bent section.

5. The wrench tool according to claim 4, further comprising a fixing member provided between the connector rod and the extension, wherein the connector and the extension are able to be fixedly fitted into the fixing member.
